(19) United States
(12) Patent Application Publication
(10) Pub. No.: US 2002/0149170 A1
(43) Pub. Date: Oct. 17, 2002

(54) Mini-bike shock absorber

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/832,809

(22) Filed: Apr. 12, 2001

(51) Int. Cl. B62K 25/06

(52) U.S. Cl. 280/283; 280/286

(57) ABSTRACT

A mini-bike shock absorber, wherein, the crossbar extends upwards from peripheral of a head tube in arc to the rear of the bike until reaching and connecting to the seat tube. A pivoting tab is provided in the rear peripheral of the seat tube and a pivot is formed on the circumference at the bottom of the crossbar for the pivot to connect the seat stay that supports a rear wheel. An upright shock absorber is connected through the pivoting tab on the seat stay at where in relation to the seat tube to link to the seat stay for absorbing energy of shock transmitted from the seat stay.

### BACKGROUND OF THE INVENTION

(a) Field of the Invention

The present invention relates to a mini-bike shock absorber, and more particularly to one that effectively helps a smooth and comfortable riding of the mini-bike.

(b) Description of the Prior Art

Whereas a mini-bike generally available in the market gives an easy riding pleasure of entertaining effect and for the children it provides dual purposes of exercise and leisure activity. It is very welcome by parents. Therefore, a shock absorber is provided to the mini-bike generally available in the market for achieving more comfortable riding as illustrated in FIG. 4 of the accompany drawings. Wherein, a shock absorber (B) is provided laterally between the peripheral of a seat stay (A1) and a down-tube (A2) of a frame (A) and an axial (A3) that turns in relation to the down-tube (A2) is provided at where the seat stay (A1) is connected to the down-tube (A2). In practice, the seat stay (A1) relatively compresses upon the shock absorber (B) having the axial (A3) as the turning center to absorb the shock energy created while riding the mini-bike for it to advance firm and steady.

However, the prior art presents certain defectives essentially caused by that while the mini-bike is advancing on a rough road surface, the seat stay having the axial as its turning center lifts up and relatively compresses the shock absorber. However, said shock absorber is laterally provided on the frame, and the travel of the seat stay to lift up relates to an arc track that fails to match the laterally linear compression direction of the shock absorber, resulting in certain disengagement to compromise the shock absorption effect.

### SUMMARY OF THE INVENTION

The primary purpose of the present invention is to provide a mini-bike shock absorber. To achieve the purpose, a crossbar extends upwards from peripheral of a head tube in arc to the rear of the bike until reaching and connecting a seat tube. A pivoting tab is provided in the rear peripheral of the seat tube and a pivot formed on the circumference at the bottom of the crossbar. The pivot is connected to a seat stay that connects the rear wheel. An upright shock absorber is connected through the pivoting tab on the seat stay at where in relation to the seat tube to link to the seat stay for absorbing energy of shock from the seat stay.

### BRIEF DESCRIPTION OF THE DRAWINGS

FIG. 1 is an exploded view of the present invention.

FIG. 2 is a side view showing an assembly of the present invention.

FIG. 3 is a schematic view of the present invention in operation.

FIG. 4 is a schematic view showing a construction of the prior art of the present invention.

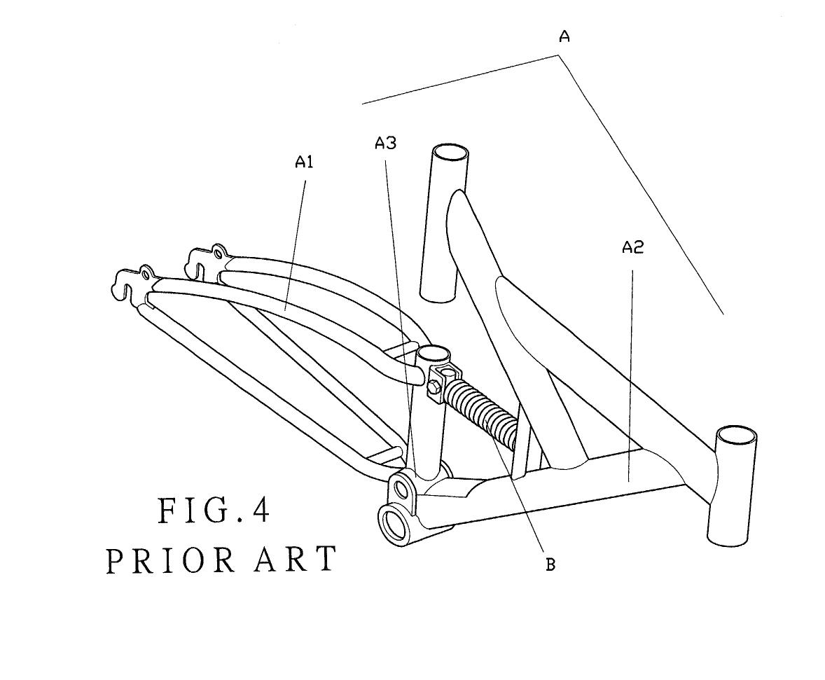

### DETAILED DESCRIPTION OF THE PREFERRED EMBODIMENTS

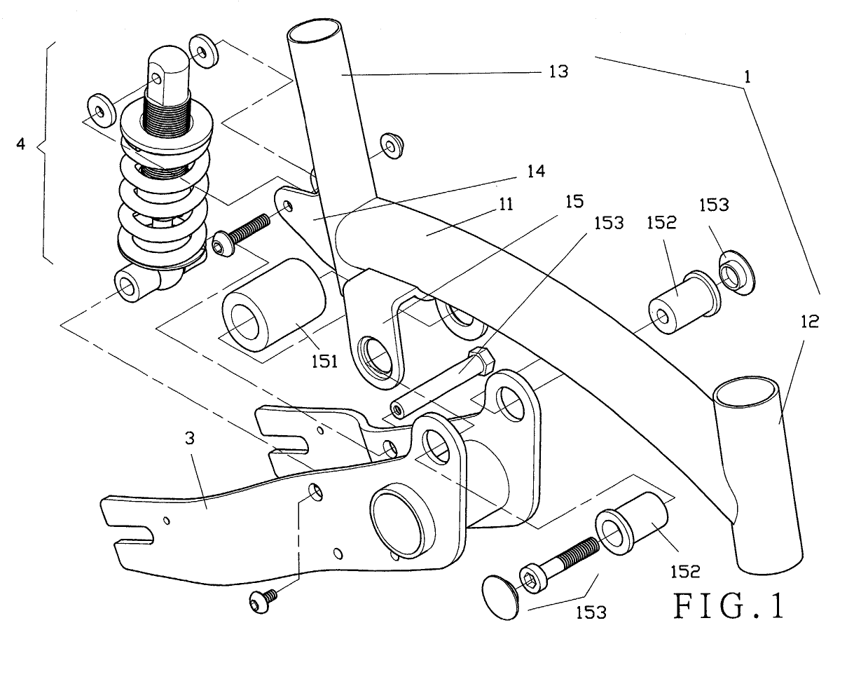

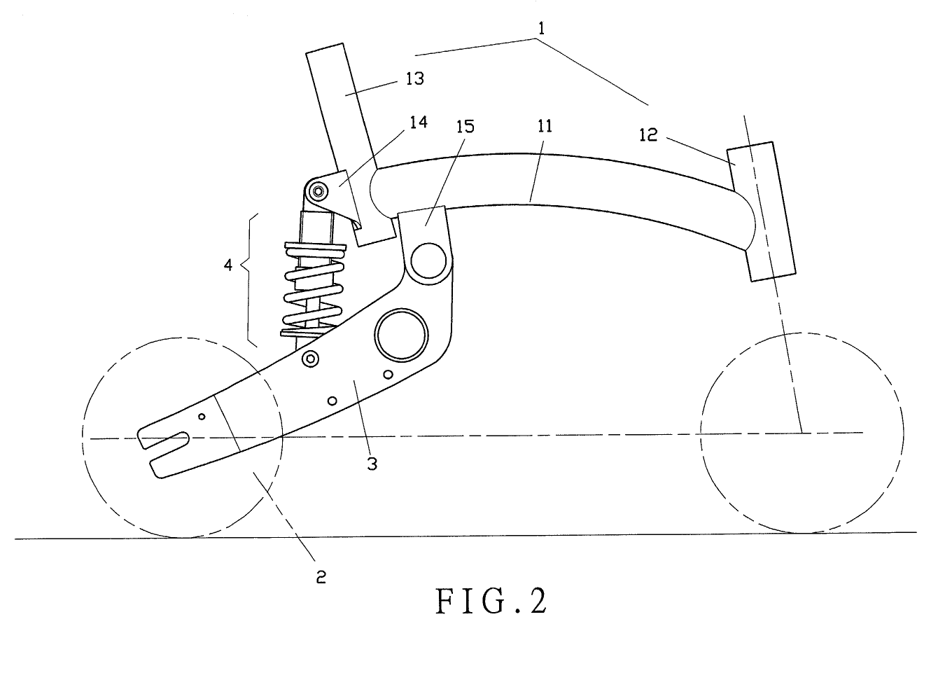

As illustrated in FIGS. 1 and 2, the present invention is essentially comprised of a crossbar (I1) of a mini-bike frame (1) to upward extend from a circumference of a head tube (12) in arc to its rear. The crossbar (11) then meets a seat tube (13) to form a tab (14) in a rear circumference of the seat tube (13). An open pivot (15) is provided at a circumference at the bottom of the crossbar (11). Then the tab (14) is pivoted to a seat stay (3) that supports a rear wheel (2) by means of said pivot (15) in conjunction with a connector (151), two sleeves (152), multiple of pivoting members (153). A pedal (not illustrated) is connected to a front end of the seat stay (3) and a shock absorber (4) is vertically provided between a middle section of the seat stay (3) and the tab (14) of the crossbar (11). The shock absorber (4) has its two ends respectively connected to the tab (14) and the seat stay (3) to be linked to the operation of the rear wheel (2) connected to an end of the seat stay (3).

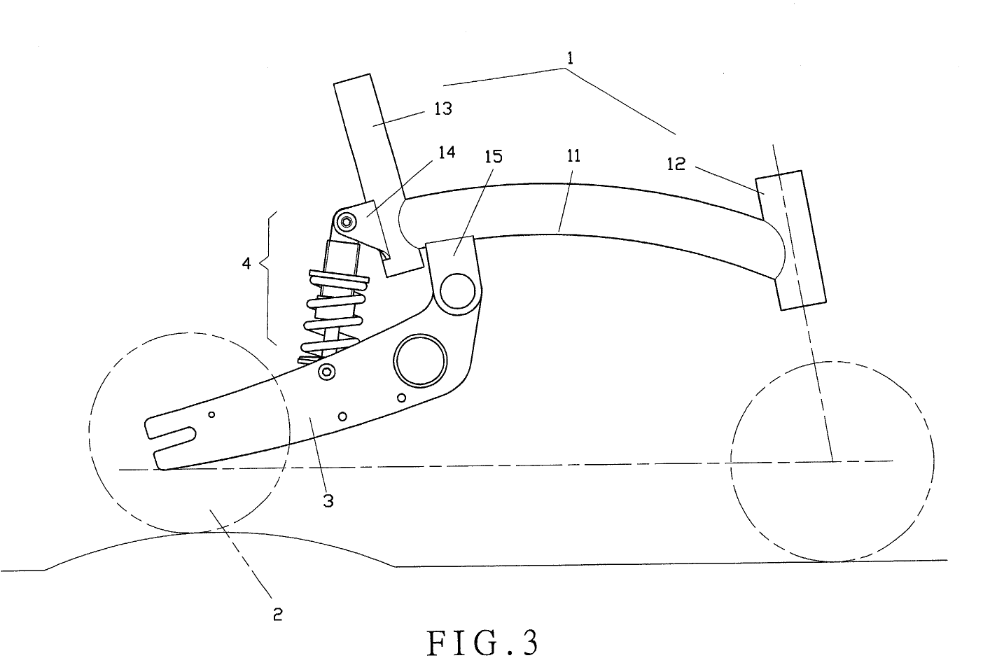

Now referring to FIGS. 2 and 3, the mini-bike is riding on a rough road surface. Wherein, the seat stay (3) having the pivot (15) as its turning center lifts up following the rear wheel (2) it is linked to. Furthermore, the shock absorber (4) connected to the seat stay (3) is relatively compressed. Since the lifting of the seat stay (3) travels in an arc track and in the same direction of that the shock absorber (4) is vertically provided, the shock absorber (4) is completely compressed when the seat stay (3) lifts up. Therefore, the present invention warrants a faithful shock absorbing effect without any compression that may go astray.

The present invention as disclosed above features compact structure and practical purpose to improve the prior art by offering a more effective shock absorption result.

I claim

1. A mini-bike shock absorber having a crossbar extending upwards from peripheral of a head tube in arc to the rear of the bike until reaching and connecting to a seat tube; a pivoting tab provided in the rear peripheral of the seat tube, a pivot formed on the circumference at the bottom of the crossbar to connect to a seat stay that supports a rear wheel; and an upright shock absorber connected through the pivoting tab on the seat stay at where in relation to the seat tube for linking to the seat stay to absorb energy of shock transmitted from the seat stay.
